(19) United States
(12) Patent Application Publication
(10) Pub. No.: US 2010/0227180 A1
(43) Pub. Date: Sep. 9, 2010

(54) COATING MATERIAL FOR METALLIC BASE MATERIAL SURFACE

(75) Inventors: Toshinari OKAGAITO, Hiroshima (JP); Yuji FUKUDA, Hiroshima (JP); Yoshitaka KOJIMA, Ibaraki (JP)

Correspondence Address: GREENBLUM & BERNSTEIN, P.L.C., 1950 ROLAND CLARKE PLACE, RESTON, VA, 20191, US

(73) Assignee: BABCOCK-HITACHI KABUSHIKI KAISHA, Tokyo (JP)

(21) Appl. No.: 12/398,577

(22) Filed: Mar. 5, 2009

(51) Int. Cl. B32B 15/00; C22C 38/02

(52) U.S. Cl. 428/457; 420/117

(57) ABSTRACT

A spraying material for coating a metallic member, being inexpensive and having superior corrosion and erosion resistance even in high temperature environments, wherein the material is composed of an Fe—Si based compound and comprises an alloy composed of 10 to 35% by weight of Si and the remainder of Fe and inevitable impurities, and further, up to 5% by weight of B may be added to the material in terms of improvement in hardness and adhesiveness of the coating is provided in order to protect components such as heaters and water walls of coal fired boilers and heat exchanger tubes of fluidized bed boilers, etc., from corrosion and erosion. The spraying material is formed into a coating by, for example, high velocity flame spraying or atmospheric plasma spraying.

### TECHNICAL FIELD

The present invention relates to a surface coating material (thermal spraying material) for a metallic base material, having superior corrosion and erosion resistance in environments, such as heat exchanger tubes and water walls of coal fired boilers, heat exchanger tubes and wall surfaces of fluidized bed boilers, etc.

### BACKGROUND ART

As capabilities a coating material for the aforementioned heat exchanger tubes and wall surfaces of coal fired boilers, etc., should possess, (1) that coating has corrosion resistance in high temperature operating environment, low oxygen partial pressure and high sulfur partial pressure, and (2) that porosity of a sprayed coating can be reduced, thereupon preventing corrosive gas from penetrating into an interface between the coating and the base material are cited. At the same time, (3) resisting erosion due to coal ash is required in terms of erosion resistance for the aforementioned coating material. Also, (4) that coating is not cracked due to thermal cycles caused by operating/stopping of a boiler and removal of the slag deposit from the surface of the coating is required. In addition, since the boiler members have a wide area and thus a large amount of thermal spraying material, (5) being superior in cost efficiency is required.

As a corrosion- and erosion-resistant thermal spraying material of industrial boilers, Ni base materials such as Ni-50Cr and metallic carbide material such as Cr₃C₂/NiCr are conventionally used and coated by a high velocity flame spraying or atmospheric plasma spraying.

Although those materials have high corrosion and erosion resistance, expensive nickel (Ni) and metallic carbide are included.

Further, although a high corrosion-resistant coating can be obtained when the high velocity flame spraying is used for those materials, there is a problem that a chromic oxide lowers toughness of the coating and thus cracks and spalling are caused by thermal cycle.

Sulfidation corrosion environments of boiler furnace walls feature a high temperature at approximately 500° C., low oxygen partial pressure and high sulfur partial pressure. As elements capable of forming a stable oxide coating even in such environments, chromium (Cr), aluminum (Al) and silicon (Si) are known.

Oxide is produced due to heat of a spraying flame when a coating is formed with those elements by a spraying method. A thermal expansion coefficient of oxide is lower than that of a base material metal. In a coating which contains a large amount of oxide, operating/stopping of the boiler and removal of the slag deposit from the surface of the coating cause cracks due to thermal induced tensile stress, which results in spalling off the outer surface of the coating. As described above, there is a disadvantage that a crack due to thermal cycles tends to be caused when a sprayed coating of a simple element having corrosion resistance is used.

A high temperature- and corrosion-resistant thermal spraying material as disclosed in Patent Literature 1 is such that Si particles not more than 35% by weight are mixed into a powder having a base material composition. It is disclosed that by making into a powder with a composition similar to the base material, a difference in thermal expansion coefficient with the base material becomes small and thus a corrosion-resistant coating superior in spalling resistance can be obtained.

Patent Literature 2 discloses that a material having a main constituent of magnetite (Fe₃O₄ and/or FeFe₃O₄) and added with carbide, nitride, silicide, boride and/or oxide is sprayed on a metallic base material, and a corrosion- and erosion-resistant layer is formed on the base material.

Patent Literature 3 discloses that a bond coat layer composed of an Si compound and a top coat layer composed of SiO₂ are coated on an upper surface of a heat exchanger tube or fire grate of an air heater, a steam generator and the like by a spraying method and further the top coat layer is provided with porous sealing, thereby maintaining high temperature corrosion resistance of the base material.

[Patent Literature 1] Japanese Published Unexamined Patent Application 2005-240106

[Patent Literature 2] Japanese Translation of International Application (Kohyo) No. 2003-522289

[Patent Literature 3] Japanese Published Unexamined Patent Application 2005-272927

### DISCLOSURE OF THE INVENTION

### Problems to be Solved by the Invention

In the invention as described in the aforementioned Patent Literature 1, a thermal spraying material obtained by mixing Si powder and powder with a base material composition is used. In thermal spraying of a mixed material, part of the powder is combined in processing. However, the majority of the coating is maintained at the original composition. When the present invention is applied to a low-alloy steel base material, a thermal spraying material composition becomes a mixture of Fe particles, Si particles, and Fe—Si composition. Fe particles are inferior in corrosion resistance. Thus, superior corrosion resistance cannot be achieved by this coating.

In the invention as described in the aforementioned Patent Literature 2, the thermal spraying material is composed of magnetite with addition of carbide, nitride, silicide and boride. Although this material possesses high temperature and oxidation resistance, iron oxide is reduced into iron sulfide in environments of high temperature, low oxygen partial pressure and high sulfur partial pressure, and accordingly corrosion resistance cannot be achieved by this coating. Further, the sprayed coating composed of a mixed material of oxide-intermetallic compound becomes porous, and thus a corrosive gas passes through pores in the coating, corrosion advances on the interface between the coating and the base material.

In the invention as described in the aforementioned Patent Literature 3, this material has the same problem regarding the porosity in the coating as the above-described Patent Literature 2. As a result, a sealing treatment with an inorganic glass material is required in order to fill the pores within the top coat. The sealing treatment is such that slurry of inorganic glass such as aluminosilicate glass is applied on a surface of the sprayed coating, heated at approximately 1000° C. Since thermal deformation and strength reduction in the member occur due to the sealing treatment, the invention cannot be applied to a low-alloy steel base material. The same applies to the bond coat layer. Although an Si compound layer composed of Cr₃Ni₅Si, Fe₃Si and Cr₃Si, etc., is formed by a thermal diffusion method, this treatment also requires heating at high temperature. When the invention is applied to a low alloy steel, thermal deformation and strength reduction occur.

Accordingly, it is an object of the present invention to provide a coating material for a metallic base material capable of forming a fine coating with superior corrosion and thermal shock and thermal cycle resistance even in high temperature environments in order to protect members such as heaters and water walls of coal fired boilers, heat exchanger tubes of fluidized bed boilers, etc., from corrosion and erosion.

### Means for Solving the Problems

The aforementioned object of the present invention can be solved by the following means.

The invention according to claim 1 is a coating material for a metallic base material surface, comprising an alloy composed of 10 to 35% by weight of Si and the remainder of Fe and inevitable impurities.

The invention according to claim 2 is a coating material for a metallic base material surface, comprising an alloy composed of 10 to 35% by weight of Si, 0 to 5% by weight of B and the remainder of Fe and inevitable impurities.

The invention according to claim 3 is a high temperature- and corrosion-resistant member wherein a surface of a metallic base material is coated by at least one or more kinds of compounds among a group of iron-silicon compounds composed of Fe₃Si, Fe₂Si, Fe₅Si₃ and FeSi.

The present inventors have conducted research and then acquired from findings that a practicable, fine, corrosion- and erosion-resistant thermal spray coating can be obtained by using a spraying material whose main constituent is an iron-silicon based compound that is a compound stable and difficult to be decomposed by heat in coating process and which is classified into an appropriate particle size.

The present invention is a surface coating material of an Fe-based alloy containing 10 to 35% by weight of Si. In terms of improvement in erosion resistance, up to 5% by weight of boron, an element lowering a melting point and strengthening the bonding between particles in the coating, may be added to the above material. The spraying material is formed into a coating by a thermal spraying method as represented by a high velocity flame spraying, atmospheric plasma spraying, etc.

The coating of the metallic base material surface in the present invention exerts high corrosion resistance by being formed by an Fe—Si based compound having high corrosion resistance such as Fe₃Si, Fe₂Si, Fe₅Si₃, FeSi, etc.

A mixed material of powder with the base material composition and Si powder is used as the spraying material of the Patent Literature 1 as described in paragraph [0029], “In the embodiment, the base material 34 is a Japan Industrial Standard (JIS) SUS310S material, and accordingly mixed powder of mixing SUS310S powder and Si powder is used as the spraying material.”

When the Patent Literature 1 is applied to an iron-based base material, the powder becomes a mixture of Fe and Si. Heat quantity is insufficient to completely melt and alloy the mixed powder in the aforementioned spraying method, and a ferrite phase which is poor in corrosion resistance remains. Consequently, corrosion resistance under low oxygen partial pressure condition cannot be obtained as already described. Additionally, simple Si is high in reactivity, and mainly inclusion of oxide such as SiO₂ is caused and pores are produced in coating, whereupon adhesiveness of the coating is lowered.

For the above reasons, it is preferable to use a compound (alloy) powder obtained for example by an atomizing or crushing an ingot having the aforementioned composition, as the thermal spraying material of the present invention.

An addition amount of Si is more preferably in a range from 12 wt % where ferrite is not produced by heat in terms of corrosion resistance to 25 wt % in terms of controlling hardness of particles for lowering porosity of coating. An addition amount of B is more preferably in a range of 3 wt % or less in terms of controlling hardness of particles.

A size range of powder for high velocity flame spraying is from 10 μm to 40 μm, more preferably 10 μm to 30 μm. On the other hand, a size range of powder for atmospheric plasma spraying is from 10 μm to 150 μm, more preferably 30 μm to 60 μm.

The spraying material of the present invention is not limited to a case of being composed of only alloy powder having the aforementioned composition. As long as the outer surface of the coating is a compound with the aforementioned composition in the end, a composition of the original spraying particles, coating process, presence of a bond coat layer and presence of thermal treatment are not limited.

In addition, the sprayed coating with the aforementioned composition is composed of at least one or more kinds of Fe—Si based compounds among Fe₃Si, Fe₂Si, Fe₅Si₃ and FeSi. Since a ferrite phase that triggers deterioration of corrosion resistance and an oxide phase that triggers deterioration of thermal shock resistance are hard to produce, superior corrosion resistance and thermal shock resistance can be achieved.

A chemical composition of the spraying material according to the present invention and its limiting reasons are described.

An Fe—Si based alloy generates an iron-silicon compound such as Fe₃Si, Fe₂Si, Fe₅Si₃, FeSi, etc., and does not generate a ferrite phase by rendering the addition amount of Si at 10% by weight or more. Those iron-silicon compounds are stable and able to form a fine SiO₂ coating even under low oxygen partial pressure. Accordingly, the compounds can not only make the coating superior in corrosion resistance but also have a feature of having superior erosion resistance due to their hardness.

When the addition amount of Si is less than 10% by weight, a ferrite phase low in corrosion resistance appears on the spraying particles, and corrosion resistance is reduced. When the addition amount of Si exceeds 35% by weight, on the other hand, FeSi₂ which is easily decomposed by heat is formed. If a material containing FeSi₂ is used for coating by thermal spraying, FeSi₂ is decomposed to FeSi and Si phase. Si is easily oxidized to SiO₂. SiO₂ is poor in bonding strength and is subjected to cracks by thermal cycles or thermal shocks. In terms of thermal shock resistance, the threshold amount of Si is 35% by weight.

Addition of boron (B) to the aforementioned Fe—Si based material allows for lowering of a melting point of the spraying particles and improvement in adhesiveness of the coating. However, the hardness of the spraying particles is increased with the increase in the amount of boron, and coating formation becomes difficult. Thus, the additional amount of boron is 5% by weight at the maximum.

The high velocity flame spraying and atmospheric plasma spraying are available for coating methods of the spraying material of the present invention. In generally, the atmospheric plasma spraying is an unsuitable for hard facing for erosion protection. However, the spraying material of the present invention provides high corrosion- and erosion-resistance coating.

For coating formation of the material of the present invention, a particle size range needs to be 10 μm or more in terms of prevention of stoppage of a spraying gun nozzle by the powder. Further, a maximum particle size capable of forming a coating is different between both spraying methods. When a thermal spray coating is formed by the high velocity flame spraying, an optimum particle size range is preferably 10 μm to 30 μm for the purpose of preventing erosion by other spraying particles in processing. When a coating is formed by the atmospheric plasma spraying method, on the other hand, the particle size is preferably in a range of 30 μm to 60 μm in terms of controlling thermal decomposition of the particles.

The coating method of the spraying material of the present invention is not limited to the high velocity flame spraying or atmospheric plasma spraying. The coating can be formed by flame spraying and electric arc spraying as well. Except for thermal spraying, the coating can be formed by a plasma powder welding.

In addition, a cross-sectional microstructure of a high velocity flame coating of Fe-20 wt % Si of the present invention is shown by an optical microscopic image in FIG. 1.

### Effects of the Invention

As described above, the Fe—Si based spraying material exerts excellent corrosion and erosion resistance when used in corrosive and erosive environments, which are conceivable in coal-fired boiler component, such as water walls, heat exchanger tubes, etc. Therefore, the material is suitable for a coating of such a component as described above. In particular, the spraying material of the present invention is an inexpensive Fe-based material. Installation cost reduction effects can be obtained as compared with a case where conventional Ni-based powder or metal carbide powder is used.

### BRIEF DESCRIPTION OF THE DRAWING

FIG. 1 is an optical microscopic image of a cross-sectional microstructure of a high velocity flame spray coating of Fe-20 wt % Si of the present invention.

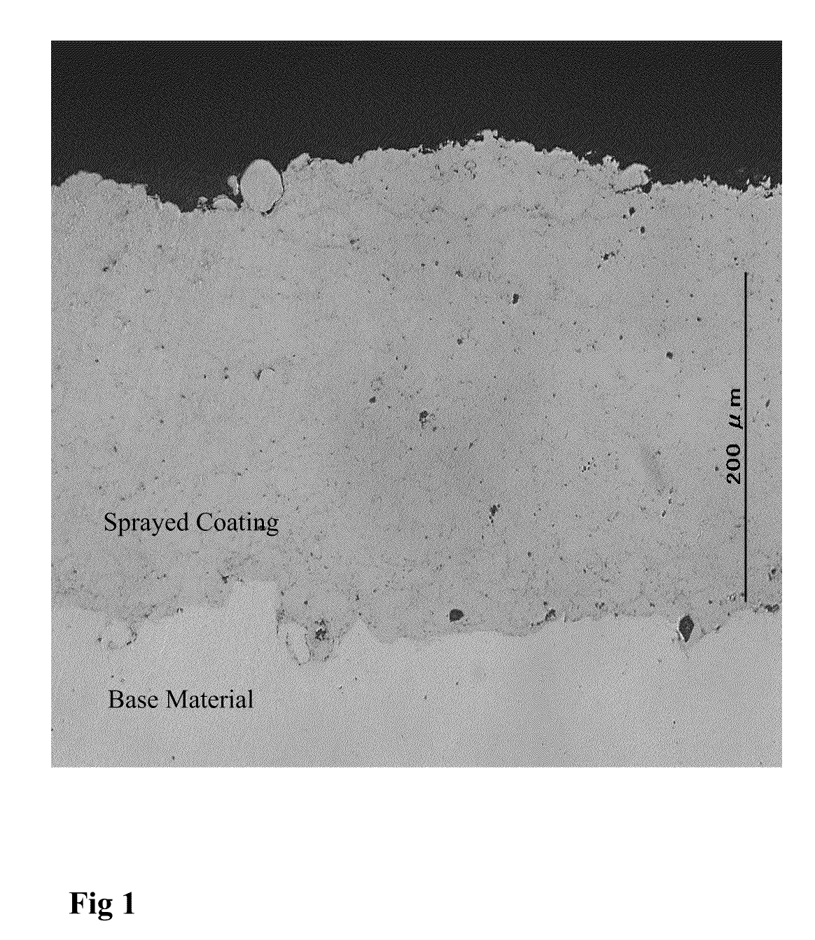

### BEST MODE FOR CARRYING OUT THE INVENTION

Hereinafter, examples of materials of the present invention are described as compared with materials having a composition within and beyond the scope of the present invention. Spraying materials having a composition of six kinds as shown in Table 1 were made into alloy powders by an atomizing, and the powder were classified through a sieve respectively. Two kinds of powders in particle size range of 10 to 30 μm and 30 to 60 μm were obtained. Coatings were formed with those powders on a surface of a 0.5 Cr to 0.5 Mo low alloy steel used as a material for boiler water walls, by the high velocity flame spraying and the atmospheric plasma spraying.

A specific coating formation condition on the high velocity flame spraying was 250 μm in coating thickness with 15 built-up layers at a propylene pressure of 700 kPa, an oxygen flow rate of 2.0×10⁻⁴ m³/s, a hydrogen flow rate of 2.7×10⁻⁴ m³/s, an air flow rate of 3.2×10⁻⁴ m³ and a powder feeding rate of 28 g/min. DJ-2700 of Sulzer Metco Ltd. was used for a spraying device.

A specific coating formation condition on atmospheric plasma spraying coating was 250 μm in coating thickness with 20 built-up layers at 800 A and 750V as a plasma condition, an argon flow rate of 7.9×10⁻⁴ m³/s, a hydrogen flow rate of 0.6×10⁻⁴ m³/s and a powder feeding rate of 28 g/min. 9 MB of Sulzer Metco Ltd., was used for a spraying device.

TABLE 1

| | Constituent (wt %) | | | | | | | | |
|---|---|---|---|---|---|---|---|---|---|
| Material | C | Si | Mn | P | S | B | Fe | O | N |
| Example 1 | 0.013 | 14.78 | 0.01 | <0.001 | 0.001 | <0.01 | Bal. | 90 ppm | 16 ppm |
| Example 2 | 0.018 | 19.82 | 0.01 | 0.001 | 0.001 | <0.01 | Bal. | 110 ppm | 13 ppm |
| Example 3 | 0.032 | 20.03 | 0.02 | 0.002 | 0.001 | 1.03 | Bal. | 80 ppm | 11 ppm |
| Example 4 | 0.029 | 29.44 | 0.03 | 0.003 | <0.001 | 1.02 | Bal. | 80 ppm | 11 ppm |
| Example 5 | 0.010 | 34.96 | 0.026 | 0.002 | <0.001 | <0.01 | Bal. | 80 ppm | 11 ppm |
| Comparative | 0.010 | 4.97 | 0.01 | 0.001 | <0.001 | <0.01 | Bal. | 120 ppm | 20 ppm |
| Example 1 | | | | | | | | | |
| Comparative | 0.033 | 40.50 | 0.02 | 0.003 | 0.001 | <0.01 | Bal. | 130 ppm | 15 ppm |
| Example 2 | | | | | | | | | |

Under the above-mentioned condition, a coating could be formed in the high velocity flame spraying by using the powder size range from 10 to 30 μm. In addition, the coating was impossible when the spraying particle size was 30 μm or more. Further, thermal shock test for the obtained coatings with heating at 600° C. and water-cooling for 10 times is performed. The atmospheric plasma spraying, a crack was observed in a coating with a particle size range from 10 μm to 30 μm. Since generation of SiO₂ and a difference in thermal expansion coefficient between oxides and Fe—Si particles is the main cause of cracking.

Table 2 shows particle size range where a fine coating was obtained and Table 3 shows a result of measuring a Vickers hardness of a cross section of the coating. In addition, a measuring load of the hardness was 3N, and an average of 5 times measuring was shown. Compared with HV180 which is the hardness of the base material, sprayed coatings of the examples 2 to 4 have a substantially three-fold hardness, so that high erosion resistance can be expected.

TABLE 2

| | High velocity | | Atmospheric | |
|---|---|---|---|---|
| | flame spraying | | plasma spraying | |
| | Particle size range | | | |
| | 10-30 μm | 30-60 μm | 10-30 μm | 30-60 μm |
| Example 1 | ⊚ | — | X | ⊚ |
| Example 2 | ⊚ | — | X | ⊚ |
| Example 3 | ⊚ | — | X | ⊚ |
| Example 4 | ⊚ | — | X | ⊚ |
| Example 5 | Δ | — | Δ | Δ |
| Comparative | ⊚ | ⊚ | X | X |
| example 1 | | | | |
| Comparative | — | — | X | — |
| example 2 | | | | |

⊚ . . . fine coating,
X . . . crack produced due to thermal shock (coating formation possible),
Δ . . . porous coating,
— . . . coating formation impossible due to spraying particle erosion

TABLE 3

| | |
|---|---|
| High velocity | Atmospheric |
| flame spraying | plasma spraying |

Particle size range

| | 10-30 μm | 30-60 μm |
|---|---|---|
| Example 1 | 310 | 300 |
| Example 2 | 530 | 400 |
| Example 3 | 580 | 440 |
| Example 4 | 600 | 580 |
| Example 5 | 400 | 450 |
| Comparative | 220 | 200 |
| example 1 | | |

A corrosion test of coatings under conditions of simulating an operational environment of a coal-fired boiler was carried out. The test temperature was set to 500° C., and the test time was set to 100 hours. As a simulated corrosive gas composition, a gas with a composition as shown in Table 4 was supplied at a flow rate of 100 ml/min in order to bring into a low oxygen partial pressure and a high sulfur partial pressure and the test was carried out.

Table 4 shows a gas composition used in the corrosion test. The gas composition was determined by a chemical-thermodynamic calculation of the equilibrium composition of high sulfur coal (sulfur content is approximately 3.3%) combustion gas at 1200° C.

TABLE 4

| | H₂S | SO₂ | CO | CO₂ | H₂ | H₂O | N₂ |
|---|---|---|---|---|---|---|---|
| Composition | 0.22% | 0.14% | 6.3% | 13.0% | 1.8% | 10.0% | Bal |
| (Volume | | | | | | | |
| fraction) | | | | | | | |

TABLE 5

| | |
|---|---|
| High velocity | Atmospheric |
| flame spraying | plasma spraying |

Particle size range

| | 10-30 μm | 30-60 μm |
|---|---|---|
| Example 1 | 0.23 | 0.50 |
| Example 2 | 0.04 | 0.21 |
| Example 3 | 0.04 | 0.18 |
| Example 4 | 0.28 | 0.30 |
| Example 5 | 0.35 | 0.50 |
| Comparative | Decayed due | Decayed due |
| example 1 | to corrosion | to corrosion |

| | |
|---|---|
| 0.5Cr—0.5Mo steel | 1.0 |

Table 5 shows a result of the corrosion test. These values mean a ratio of weight loss per unit area between thermal spray coatings and the base metal after removal of corrosion product after descaling treatment (specimens were washed by boiling 18 wt % sodium hydroxide+3 wt % potassium permanganate solution and boiling 10 wt % ammonium citrate solution). As for the Fe—Si based spraying materials of the examples, as shown in Table 5, the examples 2 and 3 were one twenty-fifth of the base material in the high velocity flame spray coating and approximately one-fifth in the atmospheric plasma sprayed coating within the addition amount of Si of the present invention. High thermal shock resistance, coating hardness and corrosion resistance were obtained.

On the other hand, at a content of Si higher than the range of the present invention, erosion by spraying particles occurs and the coating becomes porous, thereupon being unable to obtain a coating with high corrosion resistance. Further, at a content of Si lower than the range of the present invention, a dense coating could be obtained but was corroded and decayed by descaling treatment.

### INDUSTRIAL APPLICABILITY

The Fe—Si based material for thermal spraying of the present invention exerts high corrosion resistance since a SiO₂ coating is formed on a surface of a sprayed coating. Accordingly, the spraying material is applicable to environments of high temperature and low oxygen partial pressure, for example, coal fired boilers for power generation, fluidized bed boilers and incinerators of refuse incinerating plants.

1. A coating material for a metallic base material surface, comprising an alloy composed of 4-0 19.82 to 35% by weight of Si and the remainder of Fe and inevitable impurities.

2. A coating material for a metallic base material surface, comprising an alloy composed of 4-0 19.82 to 35% by weight of Si, 0 to 5% by weight of B and the remainder of Fe and inevitable impurities.

3. A high temperature- and corrosion-resistant member wherein a surface of a metallic base material is coated by at least one or more compounds selected from the group consisting of Fe₂Si, Fe₅Si₃ and FeSi.

4. A method for preparing a coating for a metallic base material surface, comprising an alloy composed of 19.82 to 35% by weight of Si and the remainder of Fe and inevitable impurities the method comprising,
providing a coating composition comprising Si, and the remainder of Fe and inevitable impurities; and
spraying the coating composition onto the metallic base material surface by high velocity flame spraying or atmospheric plasma spraying.

5. A method for preparing a coating for a metallic base material surface, comprising an alloy composed of 19.82 to 35% by weight of Si and the remainder of Fe and inevitable impurities the method comprising,
providing a coating composition comprising Si, B and the remainder of Fe and inevitable impurities; and
spraying the coating composition onto the metallic base material surface by high velocity flame spraying or atmospheric plasma spraying.
